(19) United States
(12) Patent Application Publication
(10) Pub. No.: US 2022/0350863 A1
(43) Pub. Date: Nov. 3, 2022

(54) TECHNOLOGY TO MINIMIZE THE NEGATIVE IMPACT OF CACHE CONFLICTS CAUSED BY INCOMPATIBLE LEADING DIMENSIONS IN MATRIX MULTIPLICATION AND CONVOLUTION KERNELS WITHOUT DIMENSION PADDING

(71) Applicant: Intel Corporation, Santa Clara, CA (US)

(72) Inventors: Yong Wu, Shanghai (CN); Xiaodong LIN, (CN); Zhong CAO, Shanghai (CN); Feng YUAN, Shanghai (CN); Hongzhen LIU, Shanghai (CN)

(21) Appl. No.: 17/764,114

(22) PCT Filed: Dec. 16, 2019
(86) PCT No.: PCT/CN2019/125599

§ 371 Date: Mar. 25, 2022

(51) Int. Cl. G06F 17/16; G06F 17/15; G06F 12/0864

(52) U.S. Cl. CPC G06F 17/16; G06F 17/153; G06F 12/0864

(57) ABSTRACT

Systems, apparatuses and methods may provide for technology that determines a ratio of floating point instructions to memory read instructions and controls a dimension size of a matrix kernel based at least in part on the ratio. In one example, the matrix kernel conducts an operation between a first matrix and a second matrix and the technology reuses elements of the first matrix for multiple vector lines of the second matrix.

### TECHNICAL FIELD

Embodiments generally relate to machine learning. More particularly, embodiments relate to deep learning technology that minimizes the negative impact of cache conflicts caused by incompatible leading dimensions in matrix multiplication and convolution kernels without dimension padding.

### BACKGROUND

Deep learning workloads may involve matrix-based multiplication and convolution operations, where matrix data is stored to cache memory for rapid retrieval. Certain combinations of cache layouts and matrix sizes, however, may result in the matrix data being evicted from the cache while still in use. As a result, a negative impact on performance may be encountered.

### BRIEF DESCRIPTION OF THE DRAWINGS

The various advantages of the embodiments will become apparent to one skilled in the art by reading the following specification and appended claims, and by referencing the following drawings, in which:

FIG. 1 is a comparative illustration of an example of a conventional matrix caching solution and a matrix caching solution according to an embodiment;

FIG. 2 is an illustration of an example of controlled matrix dimensions according to an embodiment;

FIG. 3 is a flowchart of an example of a method of operating a performance-enhanced computing system according to an embodiment;

FIG. 4 is an illustration of an example of a reuse of matrix elements according to an embodiment;

FIG. 5 is an illustration of an example of an inline copy according to an embodiment;

FIG. 6 is a flowchart of an example of a more detailed method of operating a performance-enhanced computing system according to an embodiment;

FIG. 7 is a block diagram of an example of a computation accelerator framework according to an embodiment;

FIG. 8 is a chart of an example of experimental performance data according to an embodiment;

FIG. 9 is a block diagram of an example of a performance-enhanced computing system according to an embodiment;

FIG. 10 is an illustration of an example of a semiconductor apparatus according to an embodiment;

FIG. 11 is a block diagram of an example of a processor according to an embodiment; and

FIG. 12 is a block diagram of an example of a multi-processor based computing system according to an embodiment.

### DESCRIPTION OF EMBODIMENTS

Applications such as image recognition and natural language processing (NLP) may use deep learning technology, which is a subset of artificial intelligence (AI) machine learning where a deep neural network contains multiple intermediate layers to conduct unsupervised learning from data that is unstructured or unlabeled. Due to the relatively large amounts of data involved in deep neural networks, the data may typically be organized and processed as n-dimensional arrays (e.g., tensors), which may be further partitioned into matrices. In such a case, common matrix operations may include matrix multiplication operations (e.g., “matmul” via a General Matrix Multiply/GEMM kernel), convolution operations, and so forth.

For example, a typical matrix operation might be the following matrix multiply operation:

c[m][n]=a[m][k]*b[k][n].

Where c is the output matrix (having a size of m rows by n columns), b is the input matrix (having a size if k rows by n columns, e.g., representing pixels of an image or the output of a previous layer), a is a set of weights (having a size of k rows by n columns) to be applied to the input matrix, and all of the matrixes are row-major (e.g., rows are stored contiguously in memory). In general, in the case of row-major order, the “leading dimension” for a two-dimensional array is an increment that is used to find the starting point for the matrix elements in each successive row of the array. Thus, k may be considered the leading dimension of matrix a and n may be considered the leading dimension of matrix b, in this example.

The matrices may be partitioned (e.g., for deployment to different processor cores). For example, after the partition each computation core might compute a subset of matrix c:

C[M][N]=A[M][K]*B[K][N],LDA=k,LDB=n,LDC=n.

Where LDA is the leading dimension of subset matrix A, LDB is the leading dimension of subset matrix B, and LDC is the leading dimension of subset matrix C. For the purposes of discussion, it may be assumed that K and N are the size of a hardware vector V for the target hardware (e.g., graphics processor, host processor, accelerator). For example, the hardware vector might be a 64-byte or 16-dword vector on a given host processor (e.g., central processing unit/CPU with Advanced Vector Extensions/AVX 512 support). As will be discussed in greater detail, the dimension size of M may be automatically controlled to a relatively small value that is limited by the number of hardware vector registers.

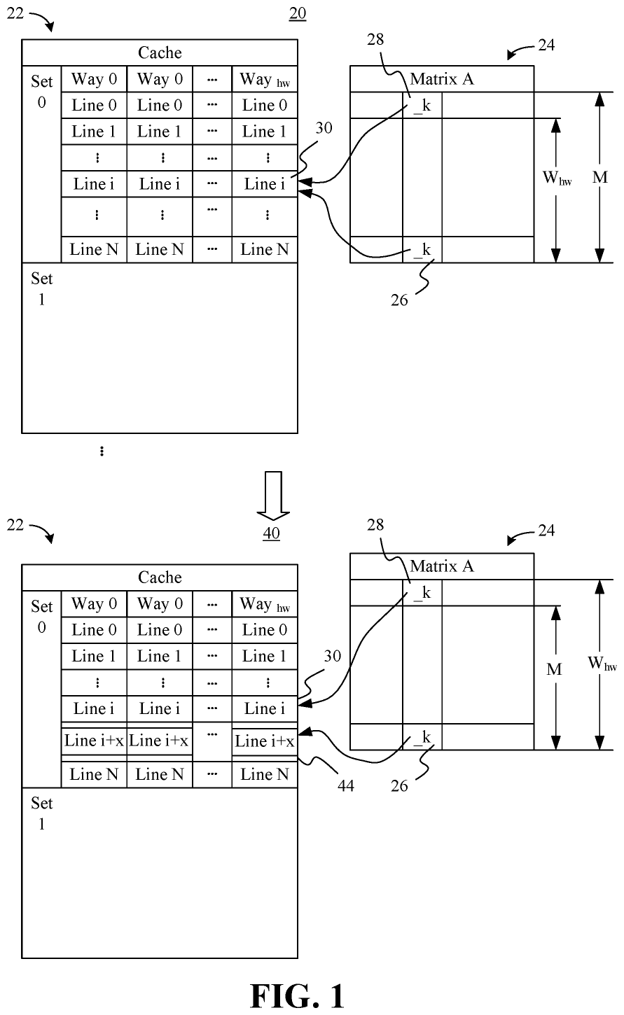

For example, FIG. 1 shows a conventional matrix caching solution 20 in which a set-associative cache 22 is organized into a plurality of sets. In general, an X-way set associative cache reduces conflicts by providing X blocks in each set where data mapping to that set might be found. While each memory address may map to a specific set, the address can map to any one of the X blocks in the set. In this example, X is also called the degree of associativity of the cache (e.g., a direct mapped cache may be another name for a one-way set associative cache). Each set may therefore contain a number of ways (degree of associativity, e.g., “Way 0, “Way 1,” and so forth) that is limited by the hardware configurations (Way_{hw}) in the processor. In the illustrated example, the M dimension of a matrix 24 (“Matrix A”) defines the height (e.g., number of rows) of the matrix 24. In the conventional matrix caching solution 20, both a first element 26 and a second element 28 of the matrix 24 may map to the same cache line 30 (“Line i”) when the leading dimension is a multiple of one cache-way size and the M dimension exceeds the number of ways in the cache 22. The result may be a cache conflict that causes the first element 26 and/or the second element 28 to be evicted from the cache 22 while still in use (e.g., reducing performance). In such a case, traveling along the M dimension could be ineffective, which leads to cache conflicts due to the incompatible (e.g., “bad”) leading dimension.

For example, if the cache 22 has a total size of 32 kB (32768 bytes) and a cache line size of 64 bytes, the cache 22 would contain 512 lines (32768 bytes/64 bytes=512 lines). Additionally, if the cache 22 is structured as an 8-way set associative cache, the number of sets would be 64 (512 lines/8 ways=64 sets). If the length of leading dimension is a multiple or factor number of sets*cache line size, the leading dimension may cause cache line conflicts. For example, despite the 8-way set associativity, addresses with same remainder of modulo 4096 (number of sets*cache line size=64*64=4096 bytes or 4 kB) are mapped to same cache line. Thus, if the leading dimension size is 256 bytes (eight bits, or 2⁸=256 bytes) for floating point instructions to (“float”) data types (e.g., element-size is 4), the length of the leading dimension will be 256 bytes*4=1024 bytes. Each fourth element of strided access along the outer dimension will have conflict cache line (1024 bytes*4 elements=4096 bytes). If the length of the leading dimension is 1024 bytes, every successive loading of the outer dimension will repeatedly load and evict the same cache line. This behavior may have a significant negative impact on deep learning performance.

By contrast, an enhanced matrix caching solution 40 controls the M dimension to be less than or equal to the number of ways in the cache 22. Accordingly, the first element 26 maps to a different cache line 44 (“Line i+x”) than the cache line 30 to which the second element 28 maps. As a result, the cache conflict is avoided and performance is enhanced, in the illustrated example.

Inside a GEMM kernel (e.g., a predefined subroutine that a math library may call to perform matrix multiplication in a nested fashion), a small matmul may be computed as below:

C[M][V]+=A[M][V]*B[V][V],LDA=k,LDB=n,LDC=n

A common method to compute the partitioned matrix multiply with vectorization register optimization is shown in the pseudo code below:

```
FOR EACH _m in M
  RESET: VC[_m] <− 0
ENDFOR
FOR EACH _k IN K = V
  LOAD VECTOR: VB <− B[_k][0... V]
  FOR EACH _m IN M
    LOAD SCALAR: t <− A[_m][_k]
    BROADCAST{1 to V}: VA <− t
    # Fused multiply and accumulation
    FMA: VC[_m] <− VB * VA + VC[_m]
  ENDFOR
ENDFOR
FOR EACH _m in M
  STORE: C[_m][0... V] <− VC[_m]
ENDFOR
```

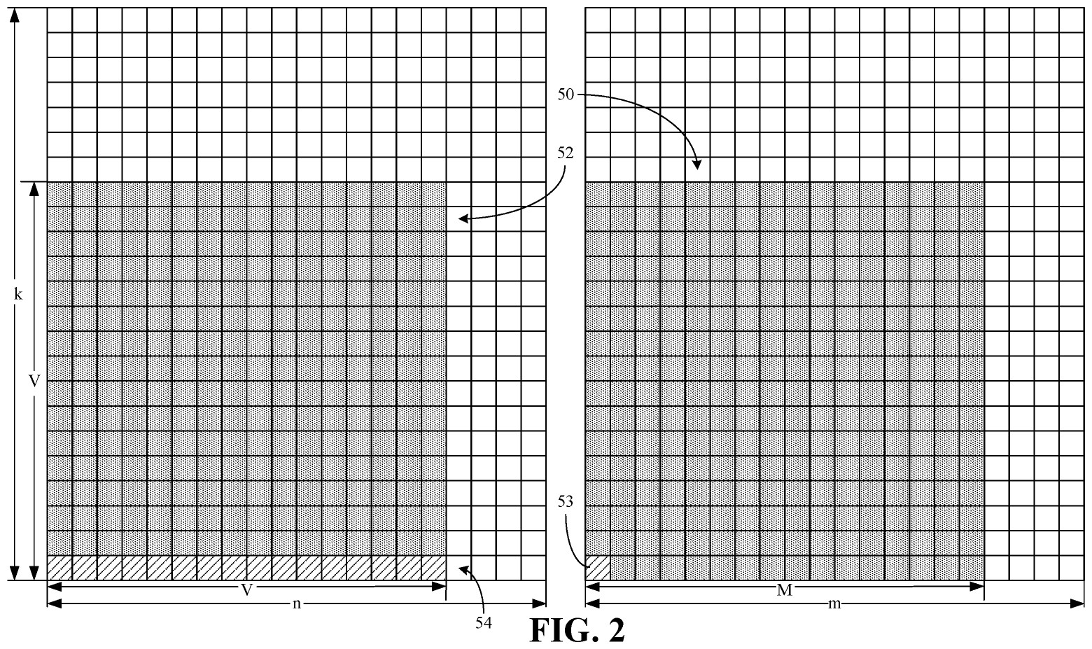

FIG. 2 demonstrates that a matrix multiplication operation between a transposed matrix 50 (e.g., transposed matrix A to ensure that the inner matrix dimensions match) and another matrix 52 (e.g., matrix B) may involve a load of a vector 54 (e.g., B[V][V], vector load of B[ _k][0], LDB=n) into a vector register, a load of a scalar element 53 (e.g., A[M][V], scalar load of A[_m][_k], LDA=k) into a scalar register, a duplicate/broadcast of the scalar load, and a vertical multiply operation. For the transposed matrix 50, the cache conflict may occur during the scalar load of matrix A: where for any_k, element A[0][_k] . . . A[M −1][_k] may share same cache line due to the LDA of matrix A being K. There may also be conflicts for the other matrix 52 (e.g., matrix B). Inside the GEMM kernel, however, each vector of the other matrix 52 may be used only once. Thus, the other matrix 52 is considered to be in “streaming mode” and does not significantly impact performance.

Based on the aforementioned common structure of the GEMM kernel, on a system with W_{hw}-way set-associative cache, cache conflicts may occur when M>W_{hw}, where W_{hw} is a fixed number (e.g., eight) on a specified hardware system. Accordingly, cache conflicts may be avoided by introducing a restriction of M<=W_{hw}, as already noted.

There may be side-effects, however, of limiting the size of M. First, there may be an impact on instruction latency. For example, a fused-multiply-and-accumulation (FMA) operation may typically have multiple cycles of latency (e.g., thirteen). Thus, a greater M helps to hide the FMA latency.

Another side-effect may be related to memory bandwidth pressure. More particularly, M determines the number of times that matrix B is reused. Thus, the greater the value of M, the more times matrix B will be reused. Essentially, this condition impacts the ratio between arithmetic floating point instructions and memory read instructions (e.g., FP Arith/Mem Rd Instructions Ratio or “FP A/R” ratio). A higher FP A/R ratio saves the cost of duplicated memory loading, which again mitigates the pressure on the cache system and improves the efficiency of memory load bandwidth. Both of these two considerations may be solved by introducing an additional reuse dimension, as will be discussed in greater detail.

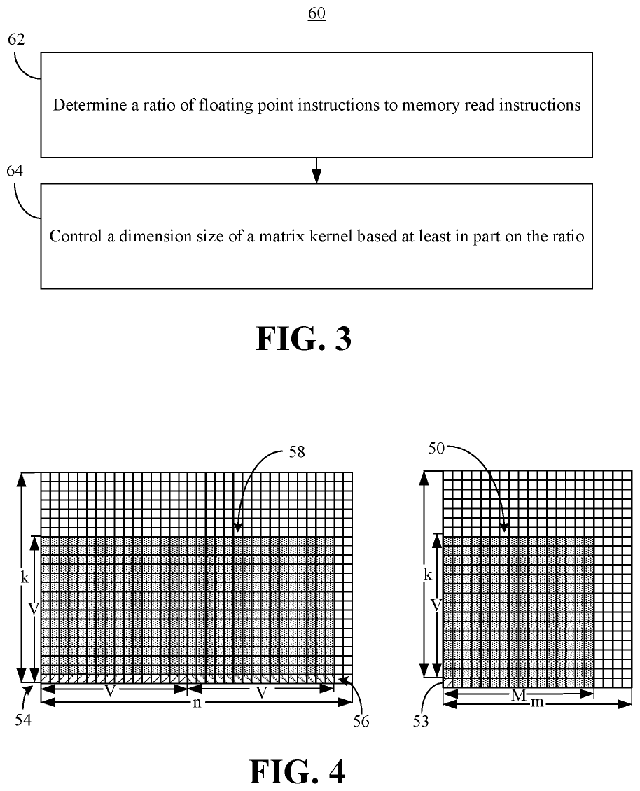

FIG. 3 shows a method 60 of operating performance-enhanced computing system. The method 60 may be implemented as one or more modules in a set of logic instructions stored in a machine- or computer-readable storage medium such as random access memory (RAM), read only memory (ROM), programmable ROM (PROM), firmware, flash memory, etc., in configurable logic such as, for example, programmable logic arrays (PLAs), field programmable gate arrays (FPGAs), complex programmable logic devices (CPLDs), in fixed-functionality hardware logic using circuit technology such as, for example, application specific integrated circuit (ASIC), complementary metal oxide semiconductor (CMOS) or transistor-transistor logic (TTL) technology, or any combination thereof.

For example, computer program code to carry out operations shown in the method 60 may be written in any combination of one or more programming languages, including an object oriented programming language such as JAVA, SMALLTALK, C++ or the like and conventional procedural programming languages, such as the “C” programming language or similar programming languages. Additionally, logic instructions might include assembler instructions, instruction set architecture (ISA) instructions, machine instructions, machine dependent instructions, microcode, state-setting data, configuration data for integrated circuitry, state information that personalizes electronic circuitry and/or other structural components that are native to hardware (e.g., host processor, central processing unit/CPU, microcontroller, etc.).

Illustrated processing block 62 provides for determining a ratio of floating point instructions to memory read instructions. Block 62 may include calculating the number of multiply and add operations per each load just before kernel execution (e.g., in real-time). Block 64 controls a dimension size (e.g., M) of a matrix kernel based at least in part on the ratio. In an embodiment, the dimension size is controlled to prevent a cache conflict. The illustrated method 60 therefore enhances performance by ensuring that an acceptable FP A/R is maintained despite the potential side-effects of controlling the dimension size of the maintenance kernel. Fewer cache conflicts may translate into less latency and improved deep learning results (e.g., shorter training times).

The matrix kernel may generally conduct an operation (e.g., multiplication operation, convolution operation) between a first matrix (e.g., matrix A) and a second matrix (e.g., matrix B). In such a case, the method 60 may further provide for reusing elements of the first matrix for multiple vector lines of the second matrix, as will be discussed in greater detail. If it is determined that a portion of the first matrix exceeds the number of ways (e.g., degree of associativity) in a set-associative cache (e.g., an overflow condition is present), block 64 may conduct an inline copy of the overflow portion in response to the overflow condition. In one example, block 64 controls the dimension size further based on a hardware constraint and/or a latency constraint.

The illustrated method 60 is also advantageous over conventional solutions that may attempt to deal with cache conflicts by performing dimension padding. For example, dimension padding solutions may pad the leading dimension to prevent the length from being a multiple of 128 B or 256 B. Normally, such an approach might add or subtract the dimension length by the size of one cache line. In deep learning (DL) workloads with DL frameworks, however, (e.g., as opposed to high performance computing/HPC workloads lacking), the shape of the tensor is a setting that is typically a fixed and agreed upon between the framework provider and the end user (e.g., customer). In addition to the performance penalty, the padded tensor generally cannot be handled by the framework provider and the end user directly, which again impacts the usability or user-experience for data scientists. Additional padding is also not a widely accepted solution because it may involve additional reordering in deep learning frameworks.

The illustrated method 60 is also advantageous over conventional solutions that may attempt to deal with cache conflicts by copying the GEMM kernel. Such solutions may apply dimension padding inside the GEMM kernel. Thus, instead of padding the entire tensor, the kernel might copy and pad a subset of data that will be handled by the current thread. Copy-GEMM kernel solutions may move the copy overhead to GEMM kernel, but the performance penalty still exists.

Turning now to FIG. 4, the density of FMAs may be increased by reusing the transposed matrix 50. In each GEMM kernel, Z vector lines of the output matrix C may be computed, as denoted below:

C[M][Z*V]=A[M][V]*B[V][Z*V],LDA=k,LDB=n,LDC=n

In the illustrated example, a vector load of B[_k][0] is conducted (e.g., with B[V][V], LDB=n) and a scalar load of A[_m][_k] is conducted (e.g., A[M][V], LDA=k). Thus, with Z>1, the transposed matrix 50 is reused multiple times, where the number of reads to the transposed matrix 50 may cause cache conflicts to be reduced to 1/Z. The new model to reducing cache-conflicts and improving FP A/R ratio involves loading two vectors 54, 56 of another matrix 58 and conducting two FMA operations for each element 53 of the transposed matrix 50. The illustrated solution therefore reduces the number of loads for the transposed matrix 50 by half. The illustrated solution also doubles the density of FMAs and increases the FP A/R ratio.

Example pseudo code to implement the enhanced solution is described as below:

```
FOR EACH _m in M
  FOR EACH _z in Z
    RESET: VC[_m][_z] <− 0
  ENDFOR
ENDFOR
FOR EACH _k IN K = V
  FOR EACH _z IN Z
    LOAD VECTOR: VB[_z] <− B[_k][_z,0... V]
  ENDFOR
FOR EACH _m IN M
  LOAD SCALAR: t <− A[_m][_k]
  BROADCAST{1 to V}: VA <− t
  # Fused multiply and accumulation
  FOR EACH _z IN Z
    FMA: VC[_m][_z] <− VB[_z] * VA + VC[_m][_z]
  ENDFOR
ENDFOR
ENDFOR
FOR EACH _m in M
  FOR EACH _z in Z
    STORE: C[_m][_z] <− VC[_m][_z]
  ENDFOR
ENDFOR
```

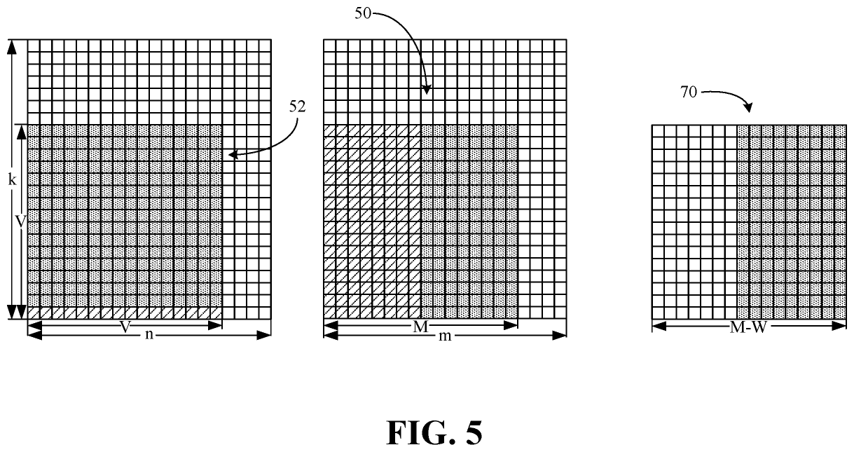

FIG. 5 demonstrates that another approach to avoid possible cache conflicts is using an additional buffer A′[M−W][V] where W is number of ways of the set-associative cache. As already noted, the number of ways may define the degree of associativity for the set-associative cache. In the illustrated example, a vector load of B[_k][0] is conducted (e.g., with B[V][V], LDB=n), a scalar load of A[_m][_k] is conducted (e.g., with A[M][V], LDA=k), and A′ [M][V] is copied to a buffer. Thus, before the FMA operation, the overflow portion (e.g., M>W) of a matrix A buffer is copied into a contiguous local buffer A′. With the additional copy, the LDA of matrix A′ is now V. Thus, the computation of matrix C can be split into two parts as below:

C[W][V]=A[W][V]*B[V][V],LDA=k,LDB=n,LDC=n

C[M−W][V]=A′[M][V]*B[V][V],LDA=V,LDB=n,LDC=n

An optimized version of the inlined copy-GEMM kernel, with leading dimension optimization, is described by the example pseudo code blow:

```
FOR EACH _m in M > W
  COPY VECTOR: VA[_m] <− A[_m][0]
ENDFOR
FOR EACH _m in M
  RESET VECTOR: VC[_m] <− 0
ENDFOR
FOR EACH _k IN K = V
  LOAD VECTOR: VB <− B[_k][0...V]
  FOR EACH _m in M <= W
    LOAD SCALAR: t <− A[_m][_k]
    BROADCAST{1 to V}: VA <− t
    # Fused multiply and accumulation
    FMA: VC[_m] <− VB * VA + VC[_m]
  ENDFOR
  FOR EACH _m IN M > W
    LOAD SCALAR: t <− VA[_m][_k]
    BROADCAST{1 to V}: VA <− t
    # Fused multiply and accumulation
    FMA: VC[_m] <− VB * VA + VC[_m]
  ENDFOR
ENDFOR
FOR EACH _m in M
  STORE: c[_m][0... V] <− VC[_m]
ENDFOR
```

The above technology to 1) use the FP A/R ratio to control the number of successive loads of matrix A, 2) conduct bilateral buffer reuse, and 3) conduct inline copies, may be combined together to further enhance performance and avoid the leading dimension issue. A fully parameterized GEMM kernel with bilateral buffer reuse may then be decided by dimension size of a single GEMM kernel, given the hardware vector size V_{hw}. Recall the matrix multiplication of

c[m][n]=a[m][k]*b[k][n].

Assuming row-major GEMM, M is number of lines in the GEMM kernel output matrix, Z is the vector size of columns of the GEMM kernel output matrix. The kernel of each small matrix multiplication may be decided by:

C[M][Z*V_{hw}]=A[M][V_{hw}]*B[V_{hw}][Z*V_{hw}].

In an embodiment, the restrictions on parameters M and Z are:

1) Hardware register restriction: Based on the computing model described herein, one register is used to load matrix A, Z registers are used to load matrix B and M*Z registers are used to save the output of matrix C. Assuming a total of R_{hw} registers, to avoid register spill, the restrictions may be given by,

(M+1)*Z+1≤R_{hw}

2) Hardware latency requirement: There may be a minimal number of pipelined vectorized FMAs Lhw to hide the FMA latency.

M*Z>L_{hw}

3) FP A/R ratio: Number of multiply and add per each load can be calculated by

$$R = \frac{M * Z * {V}_{hw}}{M * {V}_{hw} + Z * {V}_{hw}} = \frac{M * Z}{M + Z}$$

This restriction suggests that to achieve highest FP A/R ratio R, Z may be chosen to be as close as possible to M.

Based on these restrictions, the values of M and Z may be automatically selected within a few operations. For any GEMM/convolution with sufficient computation usage, the ideal M and Z may be first determined based on these restrictions. For example, in the case of thirty-two HW registers, (M,Z)=(6,4) would be the initial configuration. If there is insufficient computation (e.g., the dimension size is not large enough to saturate the core computation resources) or the dimension n is to be split further (e.g., the per-core n, i.e., N, is smaller than four), a sub-optimum solution, (M,Z)=(14,2) for example, may be used. Moreover, for any selected M, the overflow part M>priori_ratio*W_{hw} of matrix B is inline copied to a side buffer. The priori_ratio may be an empiric value based on algorithm selection on specific hardware (e.g., 0.8).

With the selected Z and M, the GEMM kernel may be automatically accelerated by bilateral buffer reuse to improve FP A/R ratio and avoid cache conflicts by reduced memory access. Further, in the case of M≤W_{hw}, the solution avoids the cache-conflict issue by fully exploiting the capacity of a multi-way set-associative cache system caused by incompatible leading dimensions. Additionally, if M>W_{hw}, the solution avoids the leading dimension issue with the inline copy.

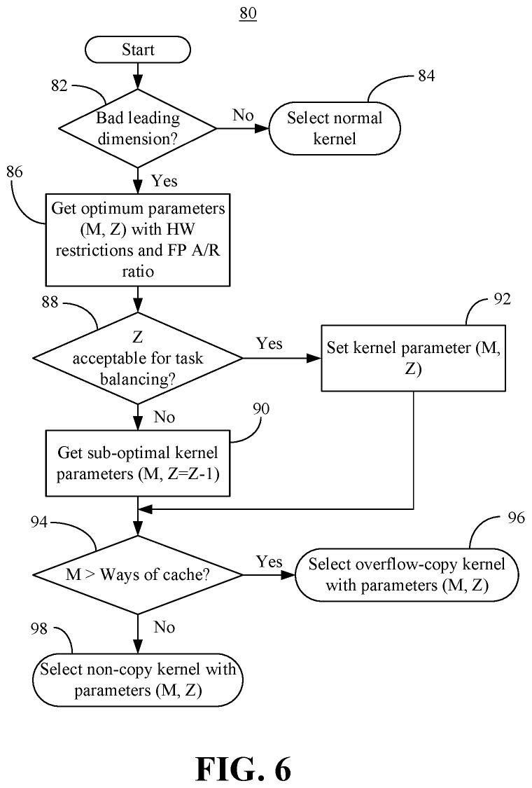

FIG. 6 shows a more detailed method 80 of operating a performance-enhanced computing system. The method 80 be implemented as one or more modules in a set of logic instructions stored in a machine- or computer-readable storage medium such as RAM, ROM, PROM, firmware, flash memory, etc., in configurable logic such as, for example, PLAs, FPGAs, CPLDs, in fixed-functionality hardware logic using circuit technology such as, for example, ASIC, CMOS or TTL technology, or any combination thereof.

Illustrated processing block 82 determines whether a bad/incompatible leading dimension has been encountered. If not, block 84 selects a normal kernel (e.g., to perform a standard matrix multiply or convolution operation). Otherwise, block 86 determines initial (e.g., “optimum”) values for parameters M and Z based on hardware (HW) restrictions and the FP A/R ratio. A determination may then be made at block 88 as to whether the value of Z is acceptable for task balancing (e.g., between available cores). If not, other (e.g., “sub-optimum”) values are selected at block 90 for parameters M and Z, and the method 80 returns to block 88. Once it is determined at block 88 that the value of Z is acceptable for task balancing, block 92 may set the kernel parameters to the values of M and Z.

Block 94 determines whether the value of M exceeds the number of ways (e.g., degree of associativity) in the cache. If so, an overflow-copy kernel is selected (e.g., to perform an inline copy of the overflow portion) at block 96 with the current values of M and Z. Otherwise, a non-copy kernel is selected (e.g., to bypass the inline copy) at block 98 with the current values of M and Z. The illustrated method 80 therefore enhances performance by ensuring that an acceptable FP A/R is maintained while obviating the potential side-effects of controlling the dimension size of the maintenance kernel. Fewer cache conflicts may translate into less latency and improved deep learning results (e.g., shorter training times).

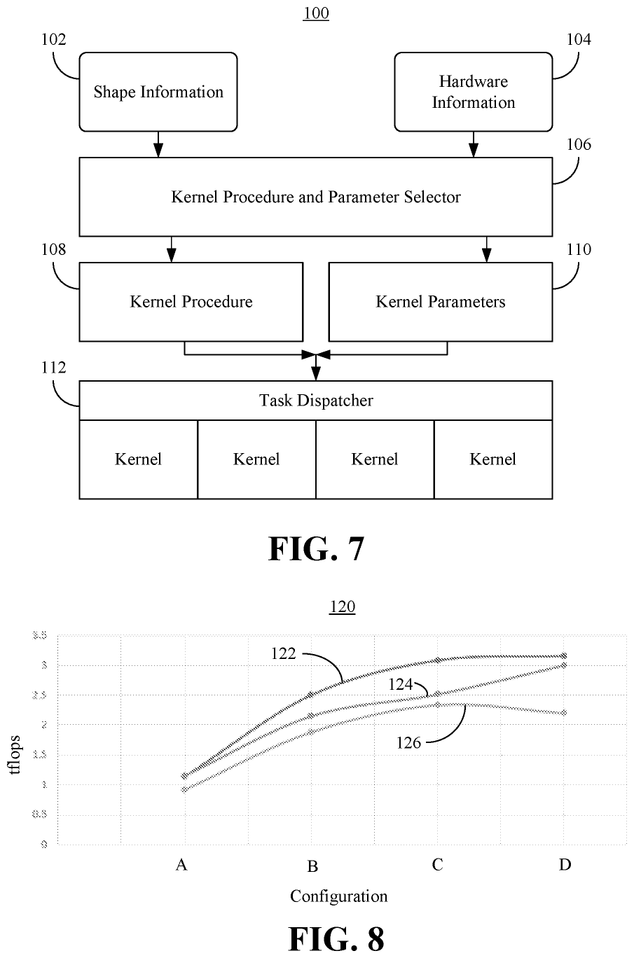

FIG. 7 shows a computation accelerator framework 100 that provides an accelerated solution for deep learning math kernels. In the illustrated example, shape information 102 (e.g., tensor and/or matrix dimension information) and hardware information 104 (e.g., cache layout, hardware vector and/or hardware register information) are input to a kernel procedure and parameter selector 106, which may be implemented in logic instructions, configurable logic, fixed-functionality hardware logic, etc., or any combination thereof. The illustrated selector 106 determines a kernel procedure 108 (e.g., normal kernel, overflow-copy kernel, non-copy kernel) and kernel parameters 110 (e.g., M, Z) based on the shape information 102 and the hardware information 104. A task dispatcher 112 launches the kernel procedure 108 as one or more kernel instances (e.g., in an execution environment that uses multiple threads to compute different partitions of primitives in parallel). Thus, performance is enhanced by extending the kernel procedure and parameter selector 106 to handle more broad scenarios and choose the best kernel procedure and kernel parameters according to the operation shape information 102 and the underlying hardware information 104.

FIG. 8 shows a chart 120 of experimental data in which the technology described herein was implemented for three different shapes of matrix multiplication with incompatible leading dimensions below:

(m,k,n)=(10752,1024,1024),shape curve 122

(m,k,n)=(1764,1024,3072),shape curve 124

(m,k,n)=(42,4096,1024),shape curve 126

For each shape, four different configurations of the parameters (M,Z) were applied, with the performance data being measured on a single socket of a processor.

(M,Z)=(28,1),configuration A

(M,Z)=(14,2),configuration B

(M,Z)=(7,2),configuration C

(M,Z)=(6,4),configuration D

In the case of an incompatible leading dimension, GEMM efficiency was relatively low in configuration A (M,Z)=(28,1), which was subjected to the cache conflicts issue. By setting Z=2 for bilateral reuse in configuration B, performance improved by ˜2x, using the same FMA pipeline length as configuration A. Configuration B still suffered, however, from the issue of cache conflicts since 14 was greater than the number of ways (8) of set-associative cache. By limiting the length of M to smaller than 8 in configuration C, an unexpected additional ˜20% benefit was achieved with (M,Z)=(7, 2), even with the pipeline lengths being reduced by half. Finally, for a shape with sufficient computations configuration D of (M,Z)=(6, 4) provided a greater FP A/R ratio, and therefore better performance. For the smallest shape curve 126 (e.g., m was not large enough for task allocation), the sub-optimum solution of (M,Z)=(7, 2) was even faster because the n dimension was used for thread level parallelism.

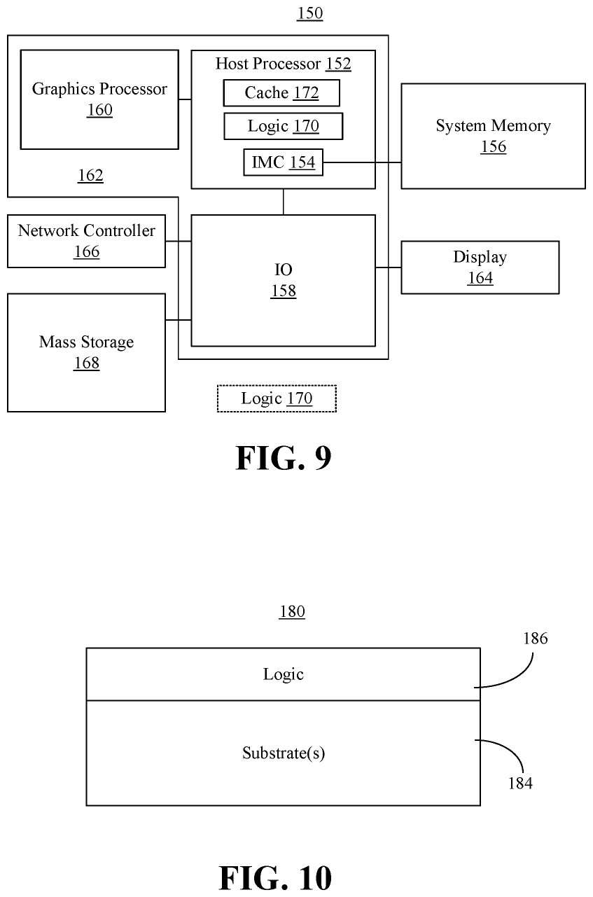

Turning now to FIG. 9, a performance-enhanced computing system 150 is shown. The system 150 may generally be part of an electronic device/platform having computing functionality (e.g., personal digital assistant/PDA, notebook computer, tablet computer, convertible tablet, server), communications functionality (e.g., smart phone), imaging functionality (e.g., camera, camcorder), media playing functionality (e.g., smart television/TV), wearable functionality (e.g., watch, eyewear, headwear, footwear, jewelry), vehicular functionality (e.g., car, truck, motorcycle), robotic functionality (e.g., autonomous robot), etc., or any combination thereof. In the illustrated example, the system 150 includes a host processor 152 (e.g., central processing unit/CPU) having a cache 172 and an integrated memory controller (IMC) 154 that is coupled to a system memory 156. In an embodiment, the cache 172 is a set-associative cache.

The illustrated system 150 also includes an input output (IO) module 158 implemented together with the host processor 152 and a graphics processor 160 on a semiconductor die 162 as a system on chip (SoC). The illustrated IO module 158 communicates with, for example, a display 164 (e.g., touch screen, liquid crystal display/LCD, light emitting diode/LED display), a network controller 166 (e.g., wired and/or wireless NIC), and mass storage 168 (e.g., hard disk drive/HDD, optical disk, solid state drive/SSD, flash memory).

In an embodiment, the host processor 152 includes logic 170 (e.g., executable logic instructions, configurable logic, fixed-functionality hardware logic, etc., or any combination thereof) to perform one or more aspects of the method 60 (FIG. 3) and/or the method 80 (FIG. 6), already discussed. Thus, the logic 170 may determine a ratio of floating point instructions to memory read instructions and control a dimension size (e.g., M) of a matrix kernel based at least in part on the ratio. In an embodiment, the dimension size is controlled to prevent a cache conflict with respect to the cache 172. The illustrated system 150 is therefore considered to be performance-enhance at least to the extent that the logic 170 ensures that an acceptable FP A/R is maintained despite the potential side-effects of controlling the dimension size of the maintenance kernel. Fewer cache conflicts may translate into less latency and improved deep learning results (e.g., shorter training times).

The matrix kernel may generally conduct an operation (e.g., multiplication operation, convolution operation) between a first matrix and a second matrix. In such a case, the logic 170 may further provide for reusing elements of the first matrix for multiple vector lines of the second matrix. If it is determined that a portion of the first matrix exceeds the number of ways in the cache 172 (e.g., an overflow condition is present), the logic 170 may also conduct an inline copy of the overflow portion in response to the overflow condition. In one example, the logic 170 controls the dimension size further based on a hardware constraint and/or a latency constraint. While the logic 170 is shown in the host processor 152, the logic 170 may reside elsewhere in the system 150.

FIG. 10 shows a semiconductor apparatus 180 (e.g., chip, die, package). The illustrated apparatus 180 includes one or more substrates 184 (e.g., silicon, sapphire, gallium arsenide) and logic 186 (e.g., transistor array and other integrated circuit/IC components) coupled to the substrate(s) 184. In an embodiment, the logic 186 implements one or more aspects of method 60 (FIG. 3) and/or the method 80 (FIG. 6), already discussed. Thus, the logic 186 may determine a ratio of floating point instructions to memory read instructions and control a dimension size (e.g., M) of a matrix kernel based at least in part on the ratio. In an embodiment, the dimension size is controlled to prevent a cache conflict. The illustrated apparatus 180 is therefore considered to be performance-enhance at least to the extent that the logic 186 ensures that an acceptable FP A/R is maintained despite the potential side-effects of controlling the dimension size of the maintenance kernel. Fewer cache conflicts may translate into less latency and improved deep learning results (e.g., shorter training times).

The logic 186 may be implemented at least partly in configurable logic or fixed-functionality hardware logic. In one example, the logic 186 includes transistor channel regions that are positioned (e.g., embedded) within the substrate(s) 184. Thus, the interface between the logic 186 and the substrate(s) 184 may not be an abrupt junction. The logic 186 may also be considered to include an epitaxial layer that is grown on an initial wafer of the substrate(s) 184.

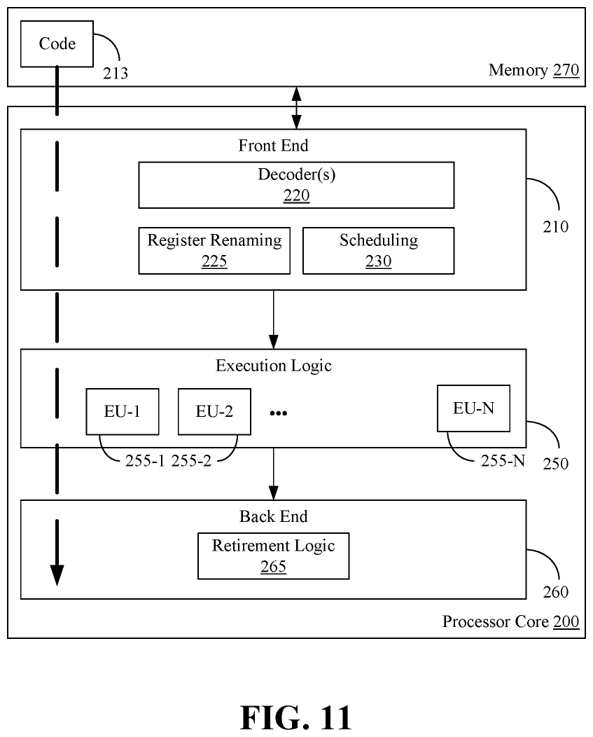

FIG. 11 illustrates a processor core 200 according to one embodiment. The processor core 200 may be the core for any type of processor, such as a micro-processor, an embedded processor, a digital signal processor (DSP), a network processor, or other device to execute code. Although only one processor core 200 is illustrated in FIG. 11, a processing element may alternatively include more than one of the processor core 200 illustrated in FIG. 11. The processor core 200 may be a single-threaded core or, for at least one embodiment, the processor core 200 may be multithreaded in that it may include more than one hardware thread context (or “logical processor”) per core.

FIG. 11 also illustrates a memory 270 coupled to the processor core 200. The memory 270 may be any of a wide variety of memories (including various layers of memory hierarchy) as are known or otherwise available to those of skill in the art. The memory 270 may include one or more code 213 instruction(s) to be executed by the processor core 200, wherein the code 213 may implement the method 60 (FIG. 3) and/or the method 80 (FIG. 6), already discussed. The processor core 200 follows a program sequence of instructions indicated by the code 213. Each instruction may enter a front end portion 210 and be processed by one or more decoders 220. The decoder 220 may generate as its output a micro operation such as a fixed width micro operation in a predefined format, or may generate other instructions, microinstructions, or control signals which reflect the original code instruction. The illustrated front end portion 210 also includes register renaming logic 225 and scheduling logic 230, which generally allocate resources and queue the operation corresponding to the convert instruction for execution.

The processor core 200 is shown including execution logic 250 having a set of execution units 255-1 through 255-N. Some embodiments may include a number of execution units dedicated to specific functions or sets of functions. Other embodiments may include only one execution unit or one execution unit that can perform a particular function. The illustrated execution logic 250 performs the operations specified by code instructions.

After completion of execution of the operations specified by the code instructions, back end logic 260 retires the instructions of the code 213. In one embodiment, the processor core 200 allows out of order execution but requires in order retirement of instructions. Retirement logic 265 may take a variety of forms as known to those of skill in the art (e.g., re-order buffers or the like). In this manner, the processor core 200 is transformed during execution of the code 213, at least in terms of the output generated by the decoder, the hardware registers and tables utilized by the register renaming logic 225, and any registers (not shown) modified by the execution logic 250.

Although not illustrated in FIG. 11, a processing element may include other elements on chip with the processor core 200. For example, a processing element may include memory control logic along with the processor core 200. The processing element may include I/O control logic and/or may include I/O control logic integrated with memory control logic. The processing element may also include one or more caches.

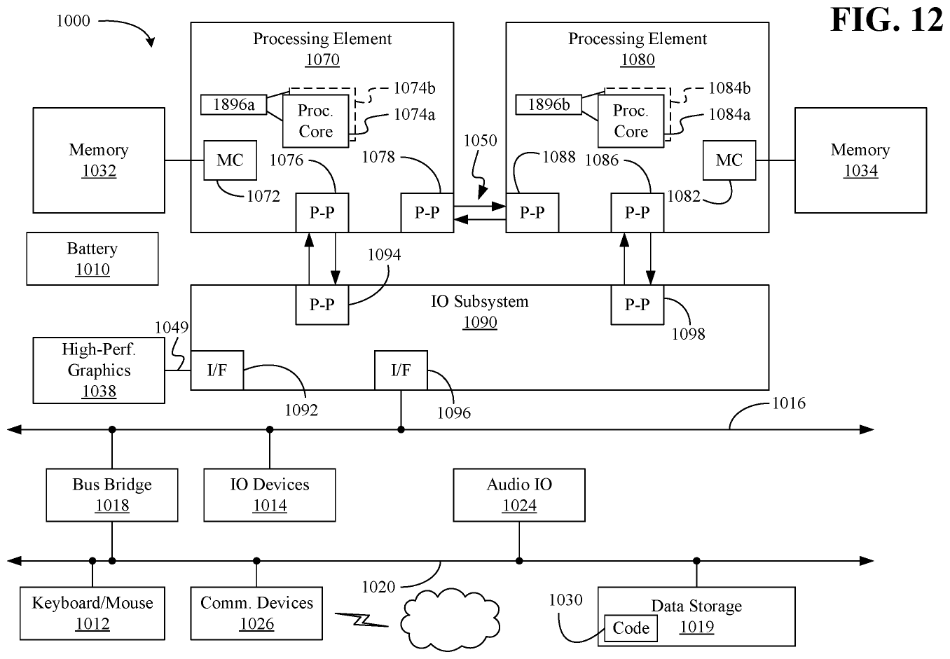

Referring now to FIG. 12, shown is a block diagram of a computing system 1000 embodiment in accordance with an embodiment. Shown in FIG. 12 is a multiprocessor system 1000 that includes a first processing element 1070 and a second processing element 1080. While two processing elements 1070 and 1080 are shown, it is to be understood that an embodiment of the system 1000 may also include only one such processing element.

The system 1000 is illustrated as a point-to-point interconnect system, wherein the first processing element 1070 and the second processing element 1080 are coupled via a point-to-point interconnect 1050. It should be understood that any or all of the interconnects illustrated in FIG. 12 may be implemented as a multi-drop bus rather than point-to-point interconnect.

As shown in FIG. 12, each of processing elements 1070 and 1080 may be multicore processors, including first and second processor cores (i.e., processor cores 1074a and 1074b and processor cores 1084a and 1084b). Such cores 1074a, 1074b, 1084a, 1084b may be configured to execute instruction code in a manner similar to that discussed above in connection with FIG. 11.

Each processing element 1070, 1080 may include at least one shared cache 1896a, 1896b. The shared cache 1896a, 1896b may store data (e.g., instructions) that are utilized by one or more components of the processor, such as the cores 1074a, 1074b and 1084a, 1084b, respectively. For example, the shared cache 1896a, 1896b may locally cache data stored in a memory 1032, 1034 for faster access by components of the processor. In one or more embodiments, the shared cache 1896a, 1896b may include one or more mid-level caches, such as level 2 (L2), level 3 (L3), level 4 (L4), or other levels of cache, a last level cache (LLC), and/or combinations thereof.

While shown with only two processing elements 1070, 1080, it is to be understood that the scope of the embodiments are not so limited. In other embodiments, one or more additional processing elements may be present in a given processor. Alternatively, one or more of processing elements 1070, 1080 may be an element other than a processor, such as an accelerator or a field programmable gate array. For example, additional processing element(s) may include additional processors(s) that are the same as a first processor 1070, additional processor(s) that are heterogeneous or asymmetric to processor a first processor 1070, accelerators (such as, e.g., graphics accelerators or digital signal processing (DSP) units), field programmable gate arrays, or any other processing element. There can be a variety of differences between the processing elements 1070, 1080 in terms of a spectrum of metrics of merit including architectural, micro architectural, thermal, power consumption characteristics, and the like. These differences may effectively manifest themselves as asymmetry and heterogeneity amongst the processing elements 1070, 1080. For at least one embodiment, the various processing elements 1070, 1080 may reside in the same die package.

The first processing element 1070 may further include memory controller logic (MC) 1072 and point-to-point (P-P) interfaces 1076 and 1078. Similarly, the second processing element 1080 may include a MC 1082 and P-P interfaces 1086 and 1088. As shown in FIG. 12, MC's 1072 and 1082 couple the processors to respective memories, namely a memory 1032 and a memory 1034, which may be portions of main memory locally attached to the respective processors. While the MC 1072 and 1082 is illustrated as integrated into the processing elements 1070, 1080, for alternative embodiments the MC logic may be discrete logic outside the processing elements 1070, 1080 rather than integrated therein.

The first processing element 1070 and the second processing element 1080 may be coupled to an I/O subsystem 1090 via P-P interconnects 1076 1086, respectively. As shown in FIG. 12, the I/O subsystem 1090 includes P-P interfaces 1094 and 1098. Furthermore, I/O subsystem 1090 includes an interface 1092 to couple I/O subsystem 1090 with a high performance graphics engine 1038. In one embodiment, bus 1049 may be used to couple the graphics engine 1038 to the I/O subsystem 1090. Alternately, a point-to-point interconnect may couple these components.

In turn, I/O subsystem 1090 may be coupled to a first bus 1016 via an interface 1096. In one embodiment, the first bus 1016 may be a Peripheral Component Interconnect (PCI) bus, or a bus such as a PCI Express bus or another third generation I/O interconnect bus, although the scope of the embodiments are not so limited.

As shown in FIG. 12, various I/O devices 1014 (e.g., biometric scanners, speakers, cameras, sensors) may be coupled to the first bus 1016, along with a bus bridge 1018 which may couple the first bus 1016 to a second bus 1020. In one embodiment, the second bus 1020 may be a low pin count (LPC) bus. Various devices may be coupled to the second bus 1020 including, for example, a keyboard/mouse 1012, communication device(s) 1026, and a data storage unit 1019 such as a disk drive or other mass storage device which may include code 1030, in one embodiment. The illustrated code 1030 may implement the method 60 (FIG. 3) and/or the method 80 (FIG. 6), already discussed, and may be similar to the code 213 (FIG. 11), already discussed. Further, an audio I/O 1024 may be coupled to second bus 1020 and a battery 1010 may supply power to the computing system 1000.

Note that other embodiments are contemplated. For example, instead of the point-to-point architecture of FIG. 12, a system may implement a multi-drop bus or another such communication topology. Also, the elements of FIG. 12 may alternatively be partitioned using more or fewer integrated chips than shown in FIG. 12.

### Additional Notes and Examples

Example 1 includes a performance-enhanced computing system comprising a network controller and a processor coupled to the network controller, wherein the processor includes a cache and logic to determine a ratio of floating point instructions to memory read instructions and control a dimension size of a matrix kernel based at least in part on the ratio.

Example 2 includes the computing system of Example 1, wherein the matrix kernel is to conduct an operation between a first matrix and a second matrix, and wherein the logic coupled to the one or more substrates is to reuse elements of the first matrix for multiple vector lines of the second matrix.

Example 3 includes the computing system of Example 2, wherein the cache is a set-associative cache, and wherein the logic is to detect an overflow condition, wherein the overflow condition includes a portion of the first matrix exceeding a number of ways in the set-associative cache, and conduct an inline copy of the portion in response to the overflow condition.

Example 4 includes the computing system of Example 2, wherein the operation is one of a multiplication operation or a convolution operation.

Example 5 includes the computing system of any one of Examples 1 to 4, wherein the dimension size is controlled further based on a hardware constraint and a latency constraint.

Example 6 includes the computing system of any one of Examples 1 to 4, wherein the dimension size is controlled to prevent a conflict in the cache.

Example 7 includes a semiconductor apparatus comprising one or more substrates, and logic coupled to the one or more substrates, wherein the logic is to implemented at least partly in one or more of configurable logic or fixed-functionality hardware logic, the logic coupled to the one or more substrates to determine a ratio of floating point instructions to memory read instructions, and control a dimension size of a matrix kernel based at least in part on the ratio.

Example 8 includes the semiconductor apparatus of Example 7, wherein the matrix kernel is to conduct an operation between a first matrix and a second matrix, and wherein the logic coupled to the one or more substrates is to reuse elements of the first matrix for multiple vector lines of the second matrix.

Example 9 includes the semiconductor apparatus of Example 8, further including a set-associative cache, wherein the logic coupled to the one or more substrates is to detect an overflow condition, wherein the overflow condition includes a portion of the first matrix exceeding a number of ways in the set-associative cache, and conduct an inline copy of the portion in response to the overflow condition.

Example 10 includes the semiconductor apparatus of Example 8, wherein the operation is one of a multiplication operation or a convolution operation.

Example 11 includes the semiconductor apparatus of any one of Examples 7 to 10, wherein the dimension size is controlled further based on a hardware constraint and a latency constraint.

Example 12 includes the semiconductor apparatus of any one of Examples 7 to 10, wherein the dimension size is controlled to prevent a cache conflict.

Example 13 includes at least one computer readable storage medium comprising a set of executable program instructions, which when executed by a computing system, cause the computing system to determine a ratio of floating point instructions to memory read instructions, and control a dimension size of a matrix kernel based at least in part on the ratio.

Example 14 includes the at least one computer readable storage medium of Example 13, wherein the matrix kernel is to conduct an operation between a first matrix and a second matrix, and wherein the instructions, when executed, further cause the computing system to reuse elements of the first matrix for multiple vector lines of the second matrix.

Example 15 includes the at least one computer readable storage medium of Example 14, wherein the instructions, when executed, further cause the computing system to detect an overflow condition, wherein the overflow condition includes a portion of the first matrix exceeding a number of ways in a set-associative cache, and conduct an inline copy of the portion in response to the overflow condition.

Example 16 includes the at least one computer readable storage medium of Example 14, wherein the operation is one of a multiplication operation or a convolution operation.

Example 17 includes the at least one computer readable storage medium of any one of Examples 13 to 16, wherein the dimension size is controlled further based on a hardware constraint and a latency constraint.

Example 18 includes the at least one computer readable storage medium of any one of Examples 13 to 16, wherein the dimension size is controlled to prevent a cache conflict.

Example 19 includes a method of operating a performance-enhanced computing system, the method comprising determining a ratio of floating point instructions to memory read instructions, and controlling a dimension size of a matrix kernel based at least in part on the ratio.

Example 20 includes the method of Example 19, wherein the matrix kernel conducts an operation between a first matrix and a second matrix, and wherein the method further includes reusing elements of the first matrix for multiple vector lines of the second matrix.

Example 21 includes the method of Example 20, further including detecting an overflow condition, wherein the overflow condition includes a portion of the first matrix exceeding a number of ways in a set-associative cache, and conducting an inline copy of the portion in response to the overflow condition.

Example 22 includes the method of Example 21, wherein the number of ways defines a degree of associativity for the set-associative cache.

Example 23 includes the method of Example 20, wherein the operation is one of a multiplication operation or a convolution operation.

Example 24 includes the method of any one of Examples 19 to 23, wherein the dimension size is controlled further based on a hardware constraint and a latency constraint.

Example 25 includes the method of any one of Examples 19 to 23, wherein the dimension size is controlled to prevent a cache conflict.

Example 26 includes means for performing the method of any one of Examples 19 to 25.

Thus, technology described herein may impose zero changes to the user data/model (e.g., compared to dimension padding solutions). The technology also comes with improved performance as it saves major memory copy/reorder overhead (e.g., compared to GEMM kernel copying solutions).

Embodiments are applicable for use with all types of semiconductor integrated circuit (“IC”) chips. Examples of these IC chips include but are not limited to processors, controllers, chipset components, programmable logic arrays (PLAs), memory chips, network chips, systems on chip (SoCs), SSD/NAND controller ASICs, and the like. In addition, in some of the drawings, signal conductor lines are represented with lines. Some may be different, to indicate more constituent signal paths, have a number label, to indicate a number of constituent signal paths, and/or have arrows at one or more ends, to indicate primary information flow direction. This, however, should not be construed in a limiting manner. Rather, such added detail may be used in connection with one or more exemplary embodiments to facilitate easier understanding of a circuit. Any represented signal lines, whether or not having additional information, may actually comprise one or more signals that may travel in multiple directions and may be implemented with any suitable type of signal scheme, e.g., digital or analog lines implemented with differential pairs, optical fiber lines, and/or single-ended lines.

Example sizes/models/values/ranges may have been given, although embodiments are not limited to the same. As manufacturing techniques (e.g., photolithography) mature over time, it is expected that devices of smaller size could be manufactured. In addition, well known power/ground connections to IC chips and other components may or may not be shown within the figures, for simplicity of illustration and discussion, and so as not to obscure certain aspects of the embodiments. Further, arrangements may be shown in block diagram form in order to avoid obscuring embodiments, and also in view of the fact that specifics with respect to implementation of such block diagram arrangements are highly dependent upon the platform within which the embodiment is to be implemented, i.e., such specifics should be well within purview of one skilled in the art. Where specific details (e.g., circuits) are set forth in order to describe example embodiments, it should be apparent to one skilled in the art that embodiments can be practiced without, or with variation of, these specific details. The description is thus to be regarded as illustrative instead of limiting.

The term “coupled” may be used herein to refer to any type of relationship, direct or indirect, between the components in question, and may apply to electrical, mechanical, fluid, optical, electromagnetic, electromechanical or other connections. In addition, the terms “first”, “second”, etc. may be used herein only to facilitate discussion, and carry no particular temporal or chronological significance unless otherwise indicated.

As used in this application and in the claims, a list of items joined by the term “one or more of” may mean any combination of the listed terms. For example, the phrases “one or more of A, B or C” may mean A, B, C; A and B; A and C; B and C; or A, B and C.

Those skilled in the art will appreciate from the foregoing description that the broad techniques of the embodiments can be implemented in a variety of forms. Therefore, while the embodiments have been described in connection with particular examples thereof, the true scope of the embodiments should not be so limited since other modifications will become apparent to the skilled practitioner upon a study of the drawings, specification, and following claims.

1-25. (canceled)

26. A computing system comprising:
a network controller; and
a processor coupled to the network controller, wherein the processor includes a cache and logic to:
determine a ratio of floating point instructions to memory read instructions, and
control a dimension size of a matrix kernel based at least in part on the ratio.

27. The computing system of claim 26, wherein the matrix kernel is to conduct an operation between a first matrix and a second matrix, and wherein the logic coupled to the one or more substrates is to reuse elements of the first matrix for multiple vector lines of the second matrix.

28. The computing system of claim 27, wherein the cache is a set-associative cache, and wherein the logic is to:
detect an overflow condition, wherein the overflow condition includes a portion of the first matrix exceeding a number of ways in the set-associative cache; and
conduct an inline copy of the portion in response to the overflow condition.

29. The computing system of claim 27, wherein the operation is one of a multiplication operation or a convolution operation.

30. The computing system of claim 26, wherein the dimension size is controlled further based on a hardware constraint and a latency constraint.

31. The computing system of claim 26, wherein the dimension size is controlled to prevent a conflict in the cache.

32. A semiconductor apparatus comprising:
one or more substrates; and
logic coupled to the one or more substrates, wherein the logic is implemented at least partly in one or more of configurable logic or fixed-functionality hardware logic, the logic coupled to the one or more substrates to:
determine a ratio of floating point instructions to memory read instructions; and
control a dimension size of a matrix kernel based at least in part on the ratio.

33. The semiconductor apparatus of claim 32, wherein the matrix kernel is to conduct an operation between a first matrix and a second matrix, and wherein the logic coupled to the one or more substrates is to reuse elements of the first matrix for multiple vector lines of the second matrix.

34. The semiconductor apparatus of claim 33, further including a set-associative cache, wherein the logic coupled to the one or more substrates is to:
detect an overflow condition, wherein the overflow condition includes a portion of the first matrix exceeding a number of ways in the set-associative cache; and
conduct an inline copy of the portion in response to the overflow condition.

35. The semiconductor apparatus of claim 33, wherein the operation is one of a multiplication operation or a convolution operation.

36. The semiconductor apparatus of claim 32, wherein the dimension size is controlled further based on a hardware constraint and a latency constraint.

37. The semiconductor apparatus of claim 32, wherein the dimension size is controlled to prevent a cache conflict.

38. At least one computer readable storage medium comprising a set of executable program instructions, which when executed by a computing system, cause the computing system to:
determine a ratio of floating point instructions to memory read instructions; and
control a dimension size of a matrix kernel based at least in part on the ratio.

39. The at least one computer readable storage medium of claim 38, wherein the matrix kernel is to conduct an operation between a first matrix and a second matrix, and wherein the instructions, when executed, further cause the computing system to reuse elements of the first matrix for multiple vector lines of the second matrix.

40. The at least one computer readable storage medium of claim 39, wherein the instructions, when executed, further cause the computing system to:
detect an overflow condition, wherein the overflow condition includes a portion of the first matrix exceeding a number of ways in a set-associative cache; and
conduct an inline copy of the portion in response to the overflow condition.

41. The at least one computer readable storage medium of claim 39, wherein the operation is one of a multiplication operation or a convolution operation.

42. The at least one computer readable storage medium of claim 38, wherein the dimension size is controlled further based on a hardware constraint and a latency constraint.

43. The at least one computer readable storage medium of claim 38, wherein the dimension size is controlled to prevent a cache conflict.

44. A method comprising:
determining a ratio of floating point instructions to memory read instructions; and
controlling a dimension size of a matrix kernel based at least in part on the ratio.

45. The method of claim 44, wherein the matrix kernel conducts an operation between a first matrix and a second matrix, and wherein the method further includes reusing elements of the first matrix for multiple vector lines of the second matrix.

46. The method of claim 45, further including:
detecting an overflow condition, wherein the overflow condition includes a portion of the first matrix exceeding a number of ways in a set-associative cache; and
conducting an inline copy of the portion in response to the overflow condition.

47. The method of claim 45, wherein the operation is one of a multiplication operation or a convolution operation.

48. The method of claim 44, wherein the dimension size is controlled further based on a hardware constraint and a latency constraint.

49. The method of claim 44, wherein the dimension size is controlled to prevent a cache conflict.
